(19) United States
(12) Patent Application Publication
(10) Pub. No.: US 2025/0315780 A1
(43) Pub. Date: Oct. 9, 2025

(54) RETURN MANAGEMENT SERVICE

(71) Applicant: American Express Travel Related Services Company, Inc., New York, NY (US)

(72) Inventor: Alaric M. Eby, Phoenix, AZ (US)

(21) Appl. No.: 18/628,920

(22) Filed: Apr. 8, 2024

(51) Int. Cl. G06Q 10/0837

(52) U.S. Cl. CPC G06Q 10/0837; G06Q 30/016

(57) ABSTRACT

Disclosed are various embodiments for a return management service that acts as an intermediary between a user (e.g., a consumer) and a merchant to intelligently recommend and initiate returns and/or refunds for the user. According to various examples, the return management service includes a large language model (LLM) that can learn from information associated with transactions, returns, and/or refunds and obtained from users, merchants, and/or issuers to proactively update, personalize for a user, provide return/refund recommendations, and carry out communications with merchants and/or issuers in line with a user's request. Users can register to participate with the return management service so that when a user wishes to return an item and/or request a refund for a purchased item or service, the user can receive a recommendation from the return management service for returning the items and/or receiving a refund.

### BACKGROUND

Items purchased by consumers may be returned to the merchant for an exchange or a refund. For example, a consumer may return an item due to unmet expectations, a damaged or defective item, buyer's remorse, a late delivery, etc. However, diverse and conflicting return/refund policies can exist across different merchants and payment issuers. In addition, policy terms can change over time and are sometimes retroactive, making it complicated for the consumer to understand how the policy may apply to his or her specific purchase based on payment method, timing, sales price, or other criteria.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a drawing depicting one of several embodiments of the present disclosure.

FIG. 2 is a drawing of a network environment according to various embodiments of the present disclosure.

FIG. 3-5 are sequence diagrams illustrating examples of functionality in the network environment of FIG. 2 according to various embodiments of the present disclosure.

### DETAILED DESCRIPTION

Disclosed are various approaches for a return management service that functions as an intermediary between a user (e.g., consumer) and a merchant to intelligently recommend and initiate returns and/or refunds for the user. According to various examples, the return management service of the present disclosure includes a large language model (LLM) that can learn from information associated with transactions, returns, and/or refunds and obtained from users, merchants, and/or issuers to proactively update, personalize for a user, provide return/refund recommendations, and carry out communications with merchants and/or issuers in line with a user's request. Users can register to participate with the return management service so that when a user wishes to return an item and/or request a refund for a purchased item or service, the user can receive a recommendation from the return management service for returning the items and/or receiving a refund. The recommendation can be based at least in part on based at least in part on the merchant's policy, the payment method, the transaction timing, the sales price, the issuer's benefits, and/or other criteria Accordingly, instead of being confused on how a particular return/refund policy may be applied for a given purchase, the user can use the recommendation to better understand how the policy may apply to his or her specific purchase and/or whether there are other benefits for the user with regard to a return and/or a refund for the item.

According to various examples, a user can register to participate with the return management service of the present disclosure. The return management service of the present disclosure acts as an intermediary between a user and a merchant with regard to item returns and/or refunds. In various examples, the return management service can track transactions of the user, and if the user wishes to request a return and/or a refund for the item, the return management service can intelligently recommend one or more paths for returning and/or obtaining a refund for the item based at least in part on various factors, including, for example, merchant data (e.g., merchant policy data, merchant communication data, etc.), user data (e.g., user communication data, payment data, user interaction history, receipts, transaction data, etc.), and/or issuer data (e.g., payment instrument benefit data, transaction data, etc.)

According to various examples, when a user registers to participate with the return management service for the present disclosure, the user can permit the return management service access to user communication data, user transaction data, user interaction history, and/or other data that the return management service can use to train an LLM and/or to provide recommendations associated with a given return/refund request. The user communication data can include emails, short messaging service (SMS) messages, and/or other types of communications that the user may have received from a merchant and/or issuer associated with a given transaction. In some examples, the user communication data can include transaction data associated with a given transaction, marketing communications received from the merchant associated with the transaction, issuer communications associated with an issuer of a payment instrument used in the transaction, shipping information, and/or other information. The user interaction history can include purchase history, rating history, search history, browsing history, and/or other type of interaction history. The user transaction data can include data associated with a given transaction. For example, the user transaction data can include a transaction receipt, payment information data, a date of transaction, a cost of transaction, whether a discount was applied, and/or other transaction data. Once a user is registered with the return management service, the return management service can periodically poll communication services and/or user devices to obtain the user-permitted user communication data, user transaction data, receipt data, and/or other data. In some examples, the user can interact with the return management service via one or more user interfaces and upload the user communication data, user transaction data, and/or other data.

The return management service can also obtain merchant data and issuer data from merchants and/or issuers. In various examples, the merchant data can include merchant policy data, merchant communication data, merchant return data, and/or other information associated with the merchant. The merchant data can be obtained from the merchant, the merchant's website, merchant marketing communications, merchant reviews, and/or other sources containing merchant information. The return management service can poll the various sources for merchant data periodically and/or in real-time to ensure up-to-date information is obtained. The issuer data can be obtained from an issuer of a payment instrument used by a user for payment of an item or service in a transaction. The issuer data can include transaction data, payment instrument benefit data, and/or other information. In various examples, the issuer data can be obtained in response to a given transaction, periodically, and/or as permitted by the user.

According to various examples, the LLM of the return management service can learn from the information obtained from users, merchants, and/or issuers associated with transactions, returns, and/or refunds, to proactively update, personalize for a user, provide return/refund recommendations, and conduct communications with merchants and/or issuers in line with a user's request. In addition, when a user decides to request a return or a refund for a given item or service purchased, the user can request the return/refund through interactions with the return management service. The return management service can obtain user data, merchant data, and issuer data associated with the given transaction and generate prompts to apply to the LLM to determine one or more recommendations for returning the item and/or requesting a refund. The one or more recommendations can be obtained from the LLM and can be based at least in part on the transaction, the user, the merchant policies, the issuer benefits, and/or other data associated with the transaction, merchant, issuer, and/or user.

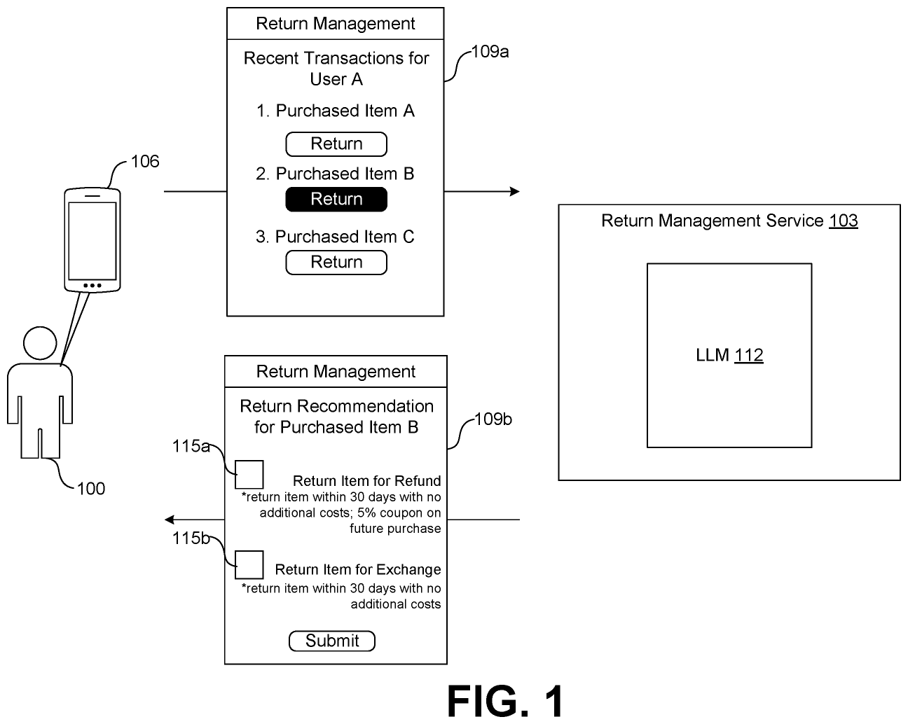

FIG. 1 illustrates an example scenario where a user 100 interacts with the return management service 103 via a client device 106 to request a return of an item purchased by the user 100. In various examples, the return management service 103 can track transactions associated with items or services purchased by the user and can present a list of transactions and/or purchases in a user interface 109a that can be rendered on a display of the client device 106. In the example of FIG. 1, the user interface 109a includes a list of items (e.g., Purchased Item A, Purchased Item B, Purchased Item C, etc.) that have been purchased by the user 100. The user 100, via the client device 106, can interact with the user interface 109a and select which item the user 100 would like to return. In this case, the user 100 has selected to return “Item B.”

In various examples, the return management service 103 can obtain user data, merchant data, and/or issuer data associated with the purchase of Item B. This information can be stored in a database and/or obtained in real-time from the user, merchant, issuer, and/or other sources that may contain information associated with the purchase of Item B. In some examples, the user data and/or the merchant data can also include persona data that relates to behaviors of the user and/or merchant with past returns. For example, if the user 100 is known to be a frequent returner, the persona data may reflect that the user 100 is a frequent returner. Alternatively, if the merchant is known to be difficult with item returns, the merchant persona may reflect the difficulty of the merchant with respect to item returns.

Upon obtaining the relevant data, the return management service 103 can generate one or more prompts based at least in part on the obtained data. A prompt can correspond to a query or text that can be used to request information from another system or service. In various examples, the prompt can be in a natural language format and can be used as an input to a large language model (LLM) 112 that is trained to output a response based on the user data of registered users, the merchant data from one or more merchants, and the issuer data of issuers associated with transactions between the users and the merchants. For example, a generated prompt may comprise “What is a return option for User A returning Item B purchased from Merchant A on Jan. 3, 2023?” The return management service 103 can apply the generated one or more prompts to the LLM 112.

The output of the LLM can include one or more recommendations that are personalized for the user 100 and are based at least in part on the user communication data (e.g., emails, SMS messages, etc.), user transaction data (e.g., receipts, payment instrument data, etc.), user interaction history, merchant communication data (e.g., marketing emails, website data, etc.), merchant policies, merchant marketing campaigns, issuer transaction data, issuer payment instrument benefits, and/or other data. It should be noted that although the LLM 112 is illustrated in FIG. 1 as being part of the return management service 103, in some examples, the LLM 112 is separate from the return management service 103. For example, the LLM 112 can correspond to a third-party LLM 112.

The return management service 103 can generate a user interface 109b that includes one or more recommendations that are output from the LLM 112. In FIG. 1, the user interface 109b includes two recommendations for the return of Item B. The return management service 103 can transmit the user interface 109b to the client device 106 of the user 100 for rendering. The user interface 109b can include one or more selectable components 115 (e.g., 115a, 115b) that upon selection by the user 100 can notify the return management service 103 the path the user 100 wishes to take with respect to the return of the item. Upon selection of a given recommendation, the return management service 103 can initiate the return of the item on behalf of the user 100.

In various examples, the return management service 103 can communicate with the merchant and/or issuer associated with the transaction to initiate the return or refund on behalf of the user 100. For example, the return management service 103 can generate a draft communication (e.g., email, SMS, etc.) based at least in part on the user's purchase of Item B, and begin a return workflow conversation with the merchant via the appropriate communication channel. In another example, the return management service 103 can initiate an outbound call to the merchant and/or issuer via a voice bot if voice functionality is required.

In the following discussion, a general description of the system and its components is provided, followed by a discussion of the operation of the same. Although the following discussion provides illustrative examples of the operation of various components of the present disclosure, the use of the following illustrative examples does not exclude other implementations that are consistent with the principals disclosed by the following illustrative examples.

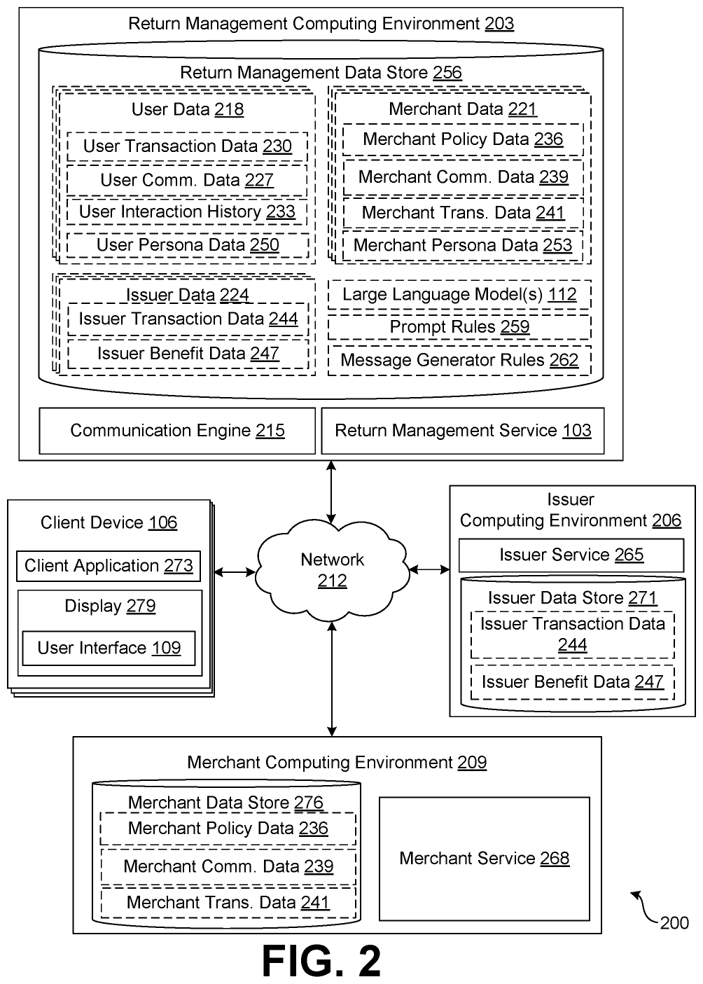

With reference to FIG. 2, shown is a network environment 200 according to various embodiments. The network environment 200 can include a return management computing environment 203, an issuer computing environment 206, a merchant computing environment 209, and a client device 106, which can be in data communication with each other via a network 212. Although not shown in FIG. 2, the network environment 200 can further include a third-party computing environment which can correspond to an email server, a social media network, an SMS server, and/or other source which may include information associated with the user, merchant, and/or issuer that is obtained by the return management service 103 for training the LLM 112 and/or using the LLM 112 to obtain recommendations for returns and/or refunds.

The network 212 can include wide area networks (WANs), local area networks (LANs), personal area networks (PANs), or a combination thereof. These networks can include wired or wireless components or a combination thereof. Wired networks can include Ethernet networks, cable networks, fiber optic networks, and telephone networks such as dial-up, digital subscriber line (DSL), and integrated services digital network (ISDN) networks. Wireless networks can include cellular networks, satellite networks, Institute of Electrical and Electronic Engineers (IEEE) 802.11 wireless networks (i.e., WI-FI®), BLUETOOTH® networks, microwave transmission networks, as well as other networks relying on radio broadcasts. The network 212 can also include a combination of two or more networks 212. Examples of networks 212 can include the Internet, intranets, extranets, virtual private networks (VPNs), and similar networks.

The return management computing environment 203, the issuer computing environment 206, and the merchant computing environment 209 can each include one or more computing devices that include a processor, a memory, and/or a network interface. For example, the computing devices can be configured to perform computations on behalf of other computing devices or applications. As another example, such computing devices can host and/or provide content to other computing devices in response to requests for content.

Moreover, the return management computing environment 203, the issuer computing environment 206, and the merchant computing environment 209 can each employ a plurality of computing devices that can be arranged in one or more server banks or computer banks or other arrangements. Such computing devices can be located in a single installation or can be distributed among many different geographical locations. For example, return management computing environment 203, the issuer computing environment 206, and/or the merchant computing environment 209 can each include a plurality of computing devices that together can include a hosted computing resource, a grid computing resource or any other distributed computing arrangement. In some cases, the return management computing environment 203, the issuer computing environment 206, and/or the merchant computing environment 209 can correspond to an elastic computing resource where the allotted capacity of processing, network, storage, or other computing-related resources can vary over time.

Various applications or other functionality can be executed in the return management computing environment 203. The components executed on the return management computing environment 203 include the return management service 103, a communication engine 215, and other applications, services, processes, systems, engines, or functionality not discussed in detail herein.

The return management service 103 can be executed to function as an intermediary between the client device 106 (e.g., user 100) and the merchant computing environment 209 (e.g., merchant) to intelligently recommend and initiate returns and/or refunds on behalf of the user. In various examples, the return management service 103 can register users 100 to participate with services provided by the return management service 103. The return management service 103 can collect data associated with registered users 100, merchants, and/or issuers. The collected data can be by the return management service 103 to track transactions, train an LLM 112, generate prompts to apply to an LLM, and/or generate return recommendations via the LLM 112 for a given transaction.

In various examples, the return management service 103 can collect user data 218, merchant data 221, and/or issuer data 224 that can be used to train the LLM 112 and can further be used to identify transactions where the user 100 has purchased items and/or services from one or more merchants. For example, during registration of a user 100, the user 100 via interactions with a user interface 109 associated with the return management service 103 can permit the return management service 103 to access user data 218. The user data 218 can include, for example, user communication data 227 associated with transactions (e.g., emails, SMS data, etc.), user transaction data 230 (e.g., transaction receipt, payment information data, a date of transaction, a cost of transaction, whether a discount was applied, etc.), user interaction history 233 (e.g., purchase history, rating history, search history, browsing history, etc.), user return data, and/or other data that the return management service 103 can use to train an LLM 112 and/or to provide recommendations associated with a given return/refund request.

Once a user 100 is registered with the return management service 103, the return management service 103 can periodically poll third-party computing environments (e.g., email servers, SMS servers, etc.) and/or client device(s) 106 associated with the user 100 to obtain the user-permitted user communication data 227, user transaction data 230, user interaction history 233, and/or other data. In some examples, the user 100 can interact with the return management service 103 via one or more user interfaces 109 and upload the user communication data 227, user transaction data 230, user interaction history 233, and/or other data to the return management service 103.

The return management service 103 can further be executed to obtain merchant data 221 from the merchant computing environment 209 or other source containing merchant data 221. In various examples, the merchant data 221 can include merchant policy data 236, merchant communication data 239, merchant transaction data 241, merchant return data, and/or other information associated with the merchant. The merchant data 221 can be obtained from the merchant computing environment 209, the merchant's website, merchant marketing communications, merchant reviews, and/or other sources containing merchant information. The return management service 103 can poll the various sources for merchant data 221 periodically and/or in real-time to ensure up-to-date information is obtained.

The return management service 103 can further be executed to obtain issuer data 224 from the issuer computing environment 206. The issuer data 224 can be obtained from an issuer of a payment instrument used by a user 100 for payment of an item or service in a transaction. The issuer data 224 can include issuer transaction data 244, issuer benefit data 247, and/or other information. In various examples, the issuer data can be obtained in response to a given transaction, periodically, and/or as permitted by the user.

In various examples, the return management service 103 can use the collected data to train an LLM 112 with respect to returns and/or refunds based at least in part on the merchant data 221, the issuer data 224, and/or the user data 218. For example, the LLM 112 can learn from the information obtained from users 100, merchants, and/or issuers associated with transactions, returns, and/or refunds, to proactively update, personalize for a user, provide return/refund recommendations, and conduct communications with merchants and/or issuers in line with a user's request.

In addition, when a user 100 decides to request a return or a refund for a given item or service purchased, the user 100 can request the return/refund through interactions with the return management service 103. The return management service 103 can obtain user data 218, merchant data 221, and issuer data 224 associated with the given transaction and generate prompts to apply to the LLM 112 to determine one or more recommendations for returning the item and/or requesting a refund. The output of the LLM 112 can include one or more recommendations that are personalized for the user 100 and are based at least in part on the user communication data 227 (e.g., emails, SMS messages, etc.), user transaction data 230 (e.g., receipts, payment instrument data, etc.), user interaction history 233, user persona data 250, merchant communication data 239 (e.g., marketing emails, website data, etc.), merchant policy data 236, merchant marketing campaigns, merchant persona data 253, issuer transaction data 244, issuer benefit data 247, and/or other data.

In various examples, the return management service 103 can be executed to generate user interfaces 109 (including user interface code) that can be rendered on a client device 106. In one non-limiting example, a generated user interfaces 109 can correspond to a user interface 109a (FIG. 1) that includes a list of transactions made by a given registered user 100. In another non-limiting example, a generated user interface 109 can correspond to a user interface 109b (FIG. 1) that includes one or more recommendations that a user 100 can select with respect to a return and/or refund associated with a purchased item or service.

The communication engine 215 can be executed to automatically generate and/or initiate communications that can be used by the return management service 103 to initiate a return and/or a refund with a merchant and/or issuer on behalf of the user 100. For example, the return management service 103 can communicate with the merchant and/or issuer associated with the transaction to indicate the return/refund request. In various examples, the communications can be in the form of a message (e.g., email, SMS), a voice call, and/or other sort of communications. In this example, the communication engine 215 can comprise a message generation service, a chatbot service, a phonebot service, and/or other type of communication service that can be automated. For example, the communication engine 215 can generate a draft communication (e.g., email, SMS) based at least in part on the user's purchase of Item B, and between a return workflow conversation with the merchant via the appropriate communication channel. In another example, the communication engine 215 can initiate an outbound call to the merchant and/or issuer via a voice bot if voice functionality is required. It should be noted that although the communication engine 215 is illustrated in FIG. 2 as being separate and distinct from the return management service 103, in some examples, the return management service 103 can include some or all of the functionality of the communication engine 215.

Also, various data is stored in a return management data store 256 that is accessible to the return management computing environment 203. The return management data store 256 can be representative of a plurality of data stores 256, which can include relational databases or non-relational databases such as object-oriented databases, hierarchical databases, hash tables or similar key-value data stores, as well as other data storage applications or data structures. Moreover, combinations of these databases, data storage applications, and/or data structures may be used together to provide a single, logical, data store. The data stored in the return management data store 256 is associated with the operation of the various applications or functional entities described below. This data can include user data 218, merchant data 221, issuer data 224, large language models 112, prompt rules 259, message generator rules 262, and potentially other data.

The user data 218 can represent data associated with a user registered with the return management service 103. The user data 218 can include, for example, user communication data 227 associated with transactions by the user 100, user transaction data 230, user interaction history 233, user persona data 250, and/or other data that the return management service 103 can use to train an LLM 112 and/or to provide recommendations associated with a given return/refund request. The user communication data 227 can include emails, SMS messages, and/or other communications received by the user 100 that may be associated with a given transaction and received within a given window associated with the transaction. For example, the user communication data 227 can include marketing emails that the user 100 received that are associated with a product that the user 100 ended up buying. In another example, the user communication data 227 can include receipts, shipping notifications, and/or other types of messages associated with a transaction.

The user transaction data 230 can include data associated with a given transaction. For example, the user transaction data 230 can include a transaction receipt, payment information data (e.g., issuer name, account number, etc.), a date of transaction, transaction amount, whether a discount was applied, shipping data, and/or other data associated with the transaction. The user interaction history 233 can include purchase history, rating history, search history, browsing history, and/or other type of interaction history by the user. For example, the user interaction history 233 can include a rating history of the user with respect to the item associated with the transaction.

The user persona data 250 can include behavior data associated with the user with respect to prior returns and/or refund request. For example, the return management service 103 can learn about the behavior of the user from an analysis of user data 218 collected from the user 100. In various examples, the user persona data 250 can indicate whether a user is a frequent returner of items, the amount of time the user has taken to return the item to the merchant, whether the user has provided reviews associated with the return process, and/or other data. In some examples, the user persona data 250 is generated by the return management service 103 in response to an analysis of collected data associated with the user 100. In other examples, the user persona data 250 can be generated by a third-party and obtained by the return management service 103.

The merchant data 221 includes information associated with one or more merchants. In various examples, the merchant data 221 can include merchant policy data 236, merchant communication data 239, merchant transaction data 241, merchant persona data 253, and/or other information associated with the merchant. The merchant data 221 can be obtained from the merchant computing environment 209, the merchant's website, merchant marketing communications, merchant reviews, and/or other sources containing merchant information. In various examples, the return management service 103 can poll the various sources for merchant data 221 periodically and/or in real-time to ensure up-to-date information is obtained.

The merchant policy data 236 includes data associated return and/or refund policies for a given merchant. For example, the merchant policy data 236 can define a merchant's policies for item returns and/or refunds and can outline how a user 100 can return purchased products and receive a refund for the product. The merchant communication data 239 can include communications sent by the merchant to one or more users 100. For example, the merchant communication data 239 can include marketing emails associated with merchant marketing campaigns, website data that can be extracted from user interfaces 109 served up by the merchant computing environment 209, and/or other types of communications sent by the merchant. The merchant transaction data 241 can include transaction data associated with one or more transactions. The transaction data can include a date of transaction, a user associated with the transaction, a price of the transaction, a product or service associated with the transaction, and/or other information that may be associated with a transaction.

The merchant persona data 253 can include behavior data associated with the merchant with respect to prior returns and/or refund request. For example, the return management service 103 can learn about the behavior of the merchant from an analysis of merchant data 221 collected from the user 100 and/or data associated with the merchant that is collected from third-party services (e.g., reviews of the merchant, etc.). In various examples, the merchant persona data 253 can indicate how easy or difficult a merchant has been with respect to past returns and/or refunds. In some examples, the merchant persona data 253 is generated by the return management service 103 in response to an analysis of collected data associated with the merchant. In other examples, the merchant persona data 253 can be generated by a third-party and obtained by the return management service 103.

The issuer data 224 can represent data associated with an issuer of a payment instrument or payment account associated with a given transaction. In various examples, the issuer data 224 can be obtained from an issuer of a payment instrument or payment account used by a user 100 for payment of an item or service in a transaction. The issuer data 224 can include issuer transaction data 244, issuer benefit data 247, and/or other information. In various examples, the issuer data can be obtained in response to a given transaction, periodically, and/or as permitted by the user 100. The issuer transaction data 244 can represent transaction data associated with a given transaction. For example, the issuer transaction data 244 can include a transaction data, a transaction amount, an item or service purchased as part of the transaction, the user 100 and merchant associated with the transaction, and/or other information associated with a transaction. The issuer benefit data 247 can define benefit associated with a given payment instrument and/or payment account. For example, the issuer may offer certain benefits based on how a user 100 uses a given payment instrument and/or payment account. The issuer benefit data 247 can define what benefits apply to the user 100 based on how the user uses the given payment instrument and/or payment account.

A large language model 112 can represent any language model that includes a neural network with many parameters (tens of thousands, millions, or sometimes even billions or more) that is trained on large quantities of unlabeled text using self-supervised learning or semi-supervised learning techniques. Some large language models 112 may be generative—that is they can generate new data based at least in part on patterns and structure learned from their input training data. Examples of large language models 112 include various versions of OPENAI's Generative Pre-trained Transformer (GPT) model (e.g., GPT-1, GPT-2, GPT-3, GPT-4, etc.), META's Large Language Model Meta AI (LLaMA), and GOOGLE's Pathways Language Model 2 (PaLM 2), among others. A large language model 112 can be configured to return a response to a prompt, which can be in a structured form (e.g., a request or prompt with a predefined schema and/or parameters) or in an unstructured form (e.g., free form or unstructured text).

In various examples, the large language model (LLM) 112 of the present disclosure can be trained to learn from information associated with transactions, returns, and/or refunds and obtained from users 100, merchants, and/or issuers (e.g., user data 218, merchant data 221, issuer data 224, etc.) in order to proactively update, personalize for a user, provide return/refund recommendations, and carry out communications with merchants and/or issuers in line with a user's request. For example, the LLM 112 can be trained to generate responses to prompts where the responses correspond to one or more recommendations for how to proceed with a return and/or refund for a given transaction.

The prompt rules 259 can include rules, models, and/or configuration data for the various algorithms or approaches employed by the return management service 103 in generating prompts that are applied to the LLM 112 when using the LLM 112 to provide return/refund recommendations for a given transaction. A prompt can correspond to a query or text that can be used to request information from another system or service. In various examples, the prompt can be in a natural language format and can be used as an input to a large language model (LLM) 112 that is trained to output a response based on the user data 218 of registered users 100, the merchant data 221, and the issuer data 224. For example, a generated prompt may comprise “What is a return option for User A returning Item B purchased from Merchant A on Jan. 3, 2023?” The return management service 103 can apply the generated one or more prompts to the LLM 112.

The message generator rules 262 can include rules, models, templates, and/or configuration data for the various algorithms or approaches employed by the communication engine 215 in generating messages or communications directed at a merchant and/or issuer in initiating a return and/or refund based at least in part on a user's desired pathway for returning an item. For example, the communication engine 215 can use the message generator rules 262 to generate a draft communication (e.g., email, SMS, etc.) based at least in part on the user's purchase of an item, and begin a return workflow conversation with the merchant and/or issuer via the appropriate communication channel. In another example, the communication engine 215 can initiate an outbound call to the merchant and/or issuer via a voice bot if voice functionality is required. The voice communications can be based at least in part on the message generator rules 262.

Various applications or other functionality can be executed in the issuer computing environment 206. The components executed on the issuer computing environment 206 include an issuer service 265, and other applications, services, processes, systems, engines, or functionality not discussed in detail herein.

The issuer service 265 can be executed to authorize transactions between a user 100 and a merchant. For example, the issuer service 265 can receive transaction details for a given transaction from a merchant service 268, a transaction terminal, and/or other device. Using the transaction details included in the request, the issuer service 265 can confirm that funds or credit is available for a given payment instrument, such that the payment transaction is authorized to proceed or not authorized to proceed.

The issuer service 265 can further be executed to interact with the return management service 103 to provide issuer transaction data 244, issuer benefit data 247, and/or other type of data that the return management service 103 may use to train the LLM 112 and/or generate a recommendation for a given return/refund request. The issuer service 265 can further interact with the return management service 103 with respect to the initiation of a return and/or refund by the return management service 103 acting on behalf of a registered user 100.

Although the issuer computing environment 206 is shown in FIG. 2 as being separate from the return management computing environment 203, in some examples, the return management computing environment 203 can integrated within the issuer computing environment 206 or the issuer computing environment 206 can be integrated within the return management computing environment 203.

Also, various data is stored in an issuer data store 271 that is accessible to the issuer computing environment 206. The issuer data store 271 can be representative of a plurality of data stores 271, which can include relational databases or non-relational databases such as object-oriented databases, hierarchical databases, hash tables or similar key-value data stores, as well as other data storage applications or data structures. Moreover, combinations of these databases, data storage applications, and/or data structures may be used together to provide a single, logical, data store. The data stored in the issuer data store 271 is associated with the operation of the various applications or functional entities described below. This data can include issuer transaction data 244, issuer benefit data 247, and potentially other data.

Various applications or other functionality can be executed in the merchant computing environment 209. The components executed on the merchant computing environment 209 include a merchant service 268, and other applications, services, processes, systems, engines, or functionality not discussed in detail herein.

The merchant service 268 can be executed to interact with a return management service 103 in providing merchant data 221 to the return management service 103. In various examples, the merchant service 268 can provide merchant policy data 236, merchant communications data 29, merchant transaction data 241, and/or any other data to the return management service 103 that the return management service 103 would need to train the LLM and generate prompts for determining a recommended path for returning an item. The merchant service 268 can further be executed to interact with the issuer service 265 in obtaining authorization for a given transaction with a user 100 associated with the client device 106. The merchant service 168 can further be executed to interact with a client application 273 of a client device 106 with respect to a given transaction.

Also, various data is stored in a merchant data store 276 that is accessible to the merchant computing environment 209. The merchant data store 276 can be representative of a plurality of data stores 276, which can include relational databases or non-relational databases such as object-oriented databases, hierarchical databases, hash tables or similar key-value data stores, as well as other data storage applications or data structures. Moreover, combinations of these databases, data storage applications, and/or data structures may be used together to provide a single, logical, data store. The data stored in the merchant data store 276 is associated with the operation of the various applications or functional entities described below. This data can include merchant policy data 236, merchant communication data 239, merchant transaction data 241, and potentially other data.

The client device 106 is representative of a plurality of client devices that can be coupled to the network 212. The client device 106 can include a processor-based system such as a computer system. Such a computer system can be embodied in the form of a personal computer (e.g., a desktop computer, a laptop computer, or similar device), a mobile computing device (e.g., personal digital assistants, cellular telephones, smartphones, web pads, tablet computer systems, music players, portable game consoles, electronic book readers, and similar devices), media playback devices (e.g., media streaming devices, BluRay® players, digital video disc (DVD) players, set-top boxes, and similar devices), a videogame console, or other devices with like capability. The client device 106 can include one or more displays 279, such as liquid crystal displays (LCDs), gas plasma-based flat panel displays, organic light emitting diode (OLED) displays, electrophoretic ink (“E-ink”) displays, projectors, or other types of display devices. In some instances, the display 279 can be a component of the client device 106 or can be connected to the client device 106 through a wired or wireless connection.

The client device 106 can be configured to execute various applications such as a client application 273 or other applications. The client application 273 can be executed in a client device 106 to access network content served up by the return management computing environment 203, the issuer computing environment 206, the merchant computing environment 209, or other servers, thereby rendering a user interface 109 on the display 279. To this end, the client application 273 can include a browser, a dedicated application, or other executable, and the user interface 109 can include a network page, an application screen, or other user mechanism for obtaining user input. The client device 106 can be configured to execute applications beyond the client application 273 such as email applications, social networking applications, word processors, spreadsheets, or other applications.

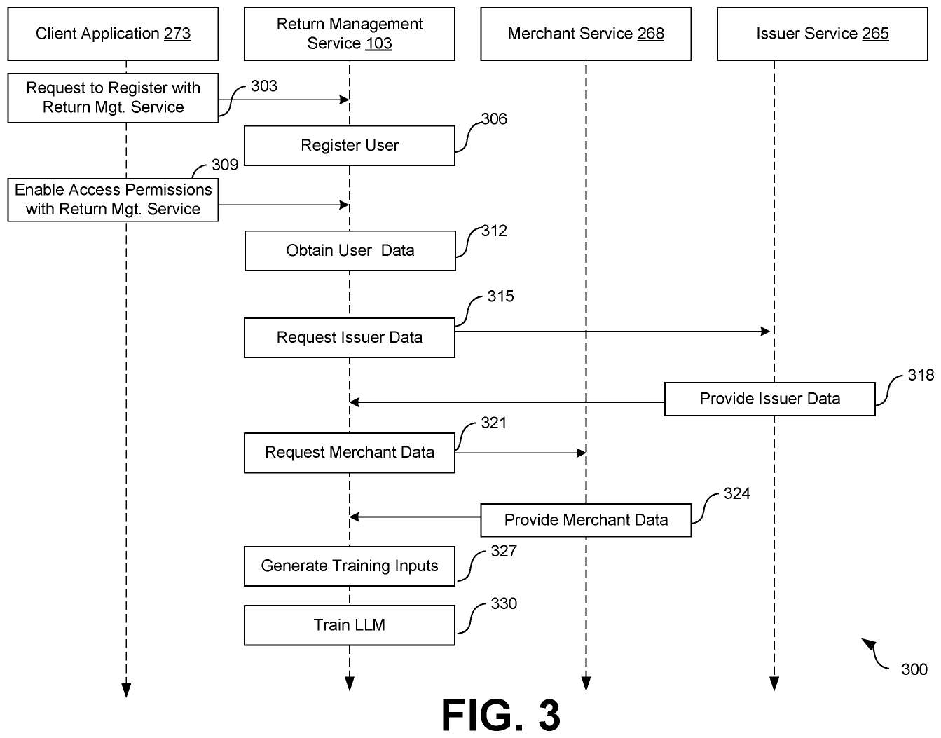

FIG. 3 illustrates a sequence diagram 300 that provides an example of the operation of the components of the network environment 200. It is understood that the sequence diagram 300 of FIG. 3 provides merely an example of the many different types of functional arrangements that can be employed to implement the operation of the depicted portion of the network environment 200. As an alternative, the sequence diagram 300 of FIG. 3 can be viewed as depicting an example of elements of a method implemented within the network environment 200. In particular, the sequence diagram 300 of FIG. 3 depicts the functionality associated with registering a user 100 with the return management service 103, collecting user data 218, merchant data 221, and issuer data 224 associated with transactions of the user, and training an LLM 112 using the collected data.

Beginning with block 303, a client application 274 can transmit a registration request to the return management service 103 to register a user 100 with the return management service 103. In various examples, the user 100 can interact with a user interface 109 served up by the return management service 103 and submit the registration request via the interactions with the user interface 109. In various examples, the registration request can include various information about the user including, the user's name, the user's physical address, the user's email address, the user's phone number, issuer information associated with one or more payment accounts and/or payment instruments used by the user 100 to purchase items and/or services, and/or other data associated with the user 100.

At block 306, the return management service 103 can register the user 100 with the return management service 103. For example, the return management service 103 can log the information associated with the user 100 and set up an account that is associated with the user 100. In addition, the return management service 103 can set up the user account for the user using default permissions that can be modified by the user 100.

At block 309, the client application 273 can enable access permissions with the return management service 103. In particular, a user 100 interacting with the user interface 109 associated with the return management service 103 can define and enable access permissions associated with the access of user data 218 by the return management service 103. In various examples, the access permissions can define what type of user data 218 (e.g., user communication data 227, user transaction data 230, user interaction history 233, etc.) the return management service 103 can obtain from the client device 106, messaging services associated with messaging accounts of the user 100 (e.g., email, SMS, etc.). In some examples, the access permissions can define the frequency of access in which return management service 103 can access the user data 218. For example, a user 100 may permit the return management service 103 access to the user data 218 once a week.

At block 312, the return management service 103 can obtain the user data 218. The user data 218 can include user communication data 227, user transaction data 230, and/or user interaction history 233. The user communication data 227 can include emails, SMS messages, and/or other communications received by the user 100 that may be associated with a given transaction and received within a given window associated with the transaction. For example, the user communication data 227 can include marketing emails that the user 100 received that are associated with a product that the user 100 ended up buying. In another example, the user communication data 227 can include receipts, shipping notifications, and/or other types of messages associated with a transaction.

The user transaction data 230 can include data associated with a given transaction. For example, the user transaction data 230 can include a transaction receipt, payment information data (e.g., issuer name, account number, etc.), a date of transaction, transaction amount, whether a discount was applied, shipping data, and/or other data associated with the transaction. The user interaction history 233 can include purchase history, rating history, search history, browsing history, and/or other type of interaction history by the user. For example, the user interaction history 233 can include a rating history of the user with respect to the item associated with the transaction.

In various examples, the return management service 103 can obtain the user data 218 from third-party computing environments (e.g., email servers, SMS servers, etc.) and/or client device(s) 106 associated with the user 100 to obtain the user-permitted user data 218. In some examples, the user 100 can interact with the return management service 103 via one or more user interfaces 109 and upload the user communication data to the return management service 103.

At block 315, the return management service 103 can send a request to the issuer service 265 for issuer data 224. The issuer data 224 can represent data associated with an issuer of a payment instrument or payment account associated with a given transaction. In various examples, the issuer data 224 can be obtained from the issuer service 265 of an issuer of a payment instrument or payment account used by a user 100 for payment of an item or service in a transaction. In various examples, the user 100 can define the issuer during registration or in response to other interactions with the return management service 103.

At block 318, the issuer service 265 can provide the issuer data 224 to the return management service 103. The issuer data 224 can include issuer transaction data 244, issuer benefit data 247, and/or other information. The issuer transaction data 244 can represent transaction data associated with a given transaction. For example, the issuer transaction data 244 can include a transaction data, a transaction amount, an item or service purchased as part of the transaction, the user 100 and merchant associated with the transaction, and/or other information associated with a transaction. The issuer benefit data 247 can define benefit associated with a given payment instrument and/or payment account. For example, the issuer may offer certain benefits based on how a user 100 uses a given payment instrument and/or payment account. The issuer benefit data 247 can define what benefits apply to the user 100 based on how the user uses the given payment instrument and/or payment account.

At block 321, the return management service 103 can request merchant data 221 from the merchant service 268. The merchant data 221 can be obtained from the merchant service 268, the merchant's website, merchant marketing communications, merchant reviews, and/or other sources containing merchant information. In various examples, the return management service 103 can poll the merchant service 268 for merchant data 221 periodically and/or in real-time to ensure up-to-date information is obtained.

At block 324, the merchant service 268 can provide the requested merchant data 221 to the merchant return service. The merchant data 221 can include information associated with one or more merchants. In various examples, the merchant data 221 can include merchant policy data 236, merchant communication data 239, merchant transaction data 241, and/or other information associated with a merchant.

At block 327, the return management service 103 can generate training inputs for training an LLM 112. The training inputs can be based at least in part on the obtained user data 218, merchant data 221, and/or issuer data 224. In various examples, the training inputs can be based at least in part on an identified transaction included in the collected data. For example, the return management service 103 can associate portions of the collected data with a given transaction. In various examples, the portions of the collected data can be based at least in part on a time window for a given identified transaction. For example, for each transaction that is identified, collected data that corresponds to the item or service of the transaction that is dated within the time window can be considered related and can be used to generate a training vector input.

At block 330, the return management service 103 can train the LLM 112 based at least in part on the generated training inputs. The LLM 12 can represent any language model that includes a neural network with many parameters (tens of thousands, millions, or sometimes even billions or more) that is trained on large quantities of unlabeled text using self-supervised learning or semi-supervised learning techniques. In various examples, the LLM 112 is generative and can generate new data based at least in part on patterns and structure learned from their input training data. It should be noted that although the example of FIG. 3 discusses training the LLM 112 based according to data associated with a registered user, the LLM 112 can be trained using data associated with multiple users. Thereafter, this portion of the process proceed to completion.

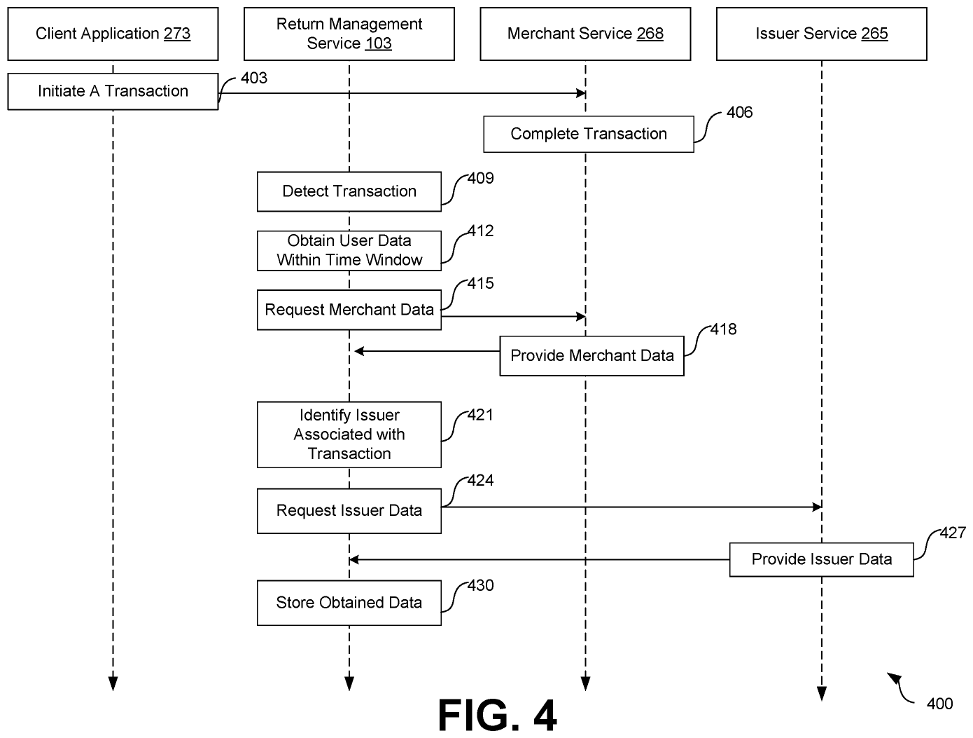

Moving on to FIG. 4, shown is a sequence diagram 400 that provides an example of the operation of the components of the network environment 200. It is understood that the sequence diagram 400 of FIG. 4 provides merely an example of the many different types of functional arrangements that can be employed to implement the operation of the depicted portion of the network environment 200. As an alternative, the sequence diagram 400 of FIG. 4 can be viewed as depicting an example of elements of a method implemented within the network environment 200. In particular, the sequence diagram 400 of FIG. 4 depicts the functionality associated with detecting a transaction associated with a registered user 100, collecting data associated with the transaction, and storing the collected data.

Beginning with block 403, the client application 273 can initiate a transaction with a merchant service 268 associated with a merchant. For example, the client application 273 can render a user interface 109 associated with the merchant service 268 that allows a user 100 interacting with the user interface 109 to request to purchase an item or service offered by the merchant. In some examples, the request the purchase the item or service can correspond to the client application 273 initiating a transaction.

At block 406, the merchant service 268 can complete the transaction. For example, the merchant service 268 can obtain payment information from the client application 273. The merchant service 268 can interact with the issuer service 265 for authorization to proceed with the transaction based at least in part on the payment information received from the client application 273. Upon receiving authorization from the issuer service 265, the merchant service 268 can complete the transaction. In some examples, the merchant service 268 can send a receipt of the transaction, shipping information, and/or other transaction related information to the client application 273.

At block 409, the return management service 103 can detect the transaction. In some examples, the return management service 103 can detect the transaction in response to the collection and analysis of user data 218, merchant data 221, and/or issuer data 224. In other examples, the client application 273 can notify the return management service 103 in response to completing a transaction.

At block 412, the return management service 103 can obtain user data 218 within a time window that is based at least in part on the date of the transaction. For example, the time window may correspond to a number of days, hours, or months, prior to the date of the transaction. The user data 218 can include user communication data 227, user transaction data 230, and/or user interaction history 233. The user communication data 227 can include emails, SMS messages, and/or other communications received by the user 100 that may be associated with a given transaction and received within a given window associated with the transaction. For example, the user communication data 227 can include marketing emails that the user 100 received that are associated with a product that the user 100 ended up buying. In another example, the user communication data 227 can include receipts, shipping notifications, and/or other types of messages associated with a transaction.

The user transaction data 230 can include data associated with a given transaction. For example, the user transaction data 230 can include a transaction receipt, payment information data (e.g., issuer name, account number, etc.), a date of transaction, transaction amount, whether a discount was applied, shipping data, and/or other data associated with the transaction. The user interaction history 233 can include purchase history, rating history, search history, browsing history, and/or other type of interaction history by the user. For example, the user interaction history 233 can include a rating history of the user with respect to the item associated with the transaction.

In various examples, the return management service 103 can obtain the user data 218 from third-party computing environments (e.g., email servers, SMS servers, etc.) and/or client device(s) 106 associated with the user 100 to obtain the user-permitted user data 218. In some examples, the user 100 can interact with the return management service 103 via one or more user interfaces 109 and upload the user communication data to the return management service 103.

At block 415, the return management service 103 can request merchant data 221 from the merchant service 268. The merchant data 221 can be obtained from the merchant service 268, the merchant's website, merchant marketing communications, merchant reviews, and/or other sources containing merchant information. In various examples, the return management service 103 can poll the merchant service 268 for merchant data 221 periodically and/or in real-time to ensure up-to-date information is obtained.

At block 418, the merchant service 268 can provide the requested merchant data 221 to the merchant return service. The merchant data 221 can include information associated with one or more merchants. In various examples, the merchant data 221 can include merchant policy data 236, merchant communication data 239, merchant transaction data 241, and/or other information associated with a merchant.

At block 424, the return management service 103 can identify an issuer associated with the transaction. For example, the user transaction data 230 can include payment information associated with the transaction and the payment information can be used to identify the issuer. In other examples, the registered user 100 may provide the return management service 103 issuer information during the registration of the user with the return management service 103.

At block 424, the return management service 103 can send a request to the issuer service 265 for issuer data 224. The issuer data 224 can represent data associated with an issuer of a payment instrument or payment account associated with a given transaction. In various examples, the issuer data 224 can be obtained from the issuer service 265 of an issuer of a payment instrument or payment account used by a user 100 for payment of an item or service in a transaction. In various examples, the user 100 can define the issuer during registration or in response to other interactions with the return management service 103.

At block 427, the issuer service 265 can provide the issuer data 224 to the return management service 103. The issuer data 224 can include issuer transaction data 244, issuer benefit data 247, and/or other information. The issuer transaction data 244 can represent transaction data associated with a given transaction. For example, the issuer transaction data 244 can include a transaction data, a transaction amount, an item or service purchased as part of the transaction, the user 100 and merchant associated with the transaction, and/or other information associated with a transaction. The issuer benefit data 247 can define benefit associated with a given payment instrument and/or payment account. For example, the issuer may offer certain benefits based on how a user 100 uses a given payment instrument and/or payment account. The issuer benefit data 247 can define what benefits apply to the user 100 based on how the user uses the given payment instrument and/or payment account.

At block 430, the return management service 103 can store the obtained data (e.g., user data 218, merchant data 221, issuer data 224, etc.) in the return management data store 256. In some examples, the obtained data is stored in association with the given transaction. In other examples, the obtained data can be stored based at least in part on the type of data. For example, the user data 218 can be stored independent of the merchant data 221 and/or issuer data 224. Thereafter, this portion of the process proceed to completion.

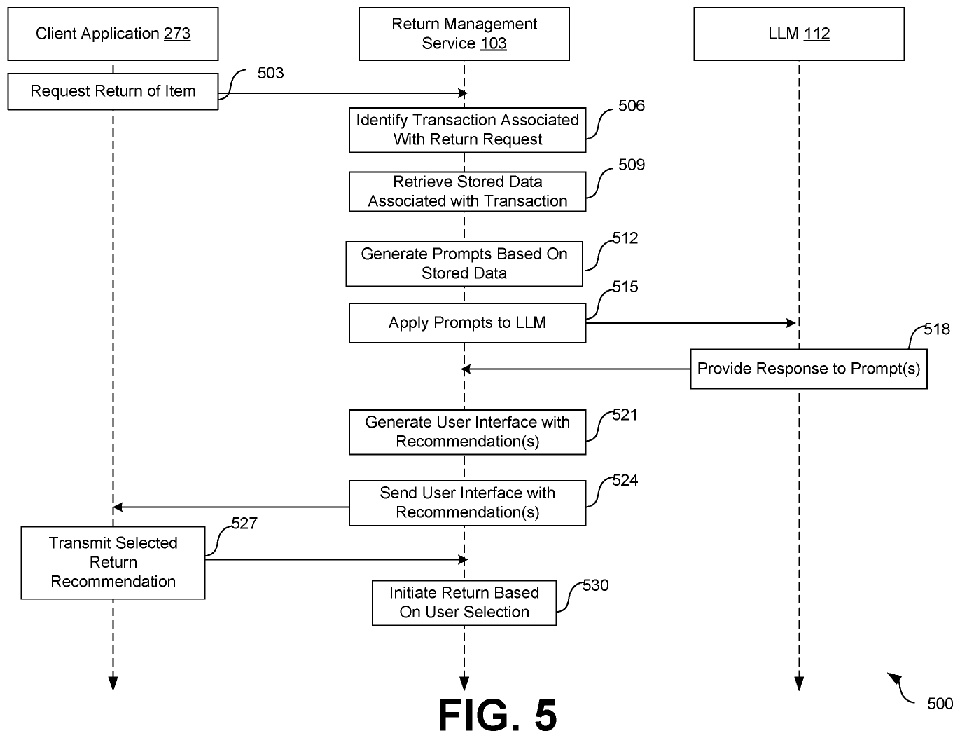

Moving on to FIG. 5, shown is a sequence diagram 500 that provides an example of the operation of the components of the network environment 200. It is understood that the sequence diagram 500 of FIG. 5 provides merely an example of the many different types of functional arrangements that can be employed to implement the operation of the depicted portion of the network environment 200. As an alternative, the sequence diagram 500 of FIG. 5 can be viewed as depicting an example of elements of a method implemented within the network environment 200. In particular, the sequence diagram 500 of FIG. 5 depicts the functionality associated with receiving a request for a return and providing recommendations to the user 100 based at least in part on an output of a trained LLM 112.

Beginning with block 503, the client application 273 can send a return request to the return management service 103. For example, a user 100 can interact via the client application 273 with the return management service 103 to request a return of an item purchased by the user 100. In some examples, the return management service 103 tracks transactions associated with items or services purchased by the user 100 and can present a list of transactions and/or purchases in a user interface 109a (FIG. 1) that can be rendered on a display of the client device 106. The user 100 can interact with the user interface 109 to select a transaction for an item they wish to return. In various examples, the selection of the transaction via the user interface 109 can correspond to the client application 273 requesting the return of an item.

At block 506, the return management service 103 can identify the transaction associated with the return request. In some examples, the return request includes a reference to the transaction. The transaction can be referenced via a date, a transaction identifier, an item identifier, and/or other type of identifier that the return management service 103 can use to identify the transaction.

At block 509, the return management service 103 can retrieve stored data that is associated with the identified transaction. The stored data can include the user data 218, merchant data 221, issuer data 224, and/or other data. In some examples, the return management service 103 can obtain user data 218, merchant data 221, and/or issuer data 224 from the respective sources in real-time in response to identifying the transaction.

At block 512, the return management service 103 can generate one or more prompts based at least in part on the retrieved data and the prompt rules 259. A prompt can correspond to a query or text that can be used to request information from another system or service. In various examples, the prompt can be in a natural language format and can be used as an input to a large language model (LLM) 112 that is trained to output a response based on the user data 218 of registered users, the merchant data 221 from one or more merchants, and the issuer data 224 of issuers associated with transactions between the users 100 and the merchants. For example, a generated prompt may comprise “What is a return option for User A returning Item B purchased from Merchant A on Jan. 3, 2023?”

At block 515, the return management service 103 can apply the generated prompt(s) to the LLM 112. According to various examples, the LLM 112 is trained to output a response to the applied prompts based on the user data of registered users, the merchant data from one or more merchants, and the issuer data of issuers associated with transactions between the users and the merchants. In some examples, the return management service 103 executes the LLM 112 by applying the prompts to the LLM 112.

At block 518, the LLM 112 can provide the response(s) to the prompt(s) to the return management system 103. In various examples, the responses of the LLM 112 can include one or more recommendations that are personalized for the user 100 and are based at least in part on the user communication data (e.g., emails, SMS messages, etc.), user transaction data (e.g., receipts, payment instrument data, etc.), user interaction history, merchant communication data (e.g., marketing emails, website data, etc.), merchant policies, merchant marketing campaigns, issuer transaction data, issuer payment instrument benefits, and/or other data. The recommendations can correspond to one or more different options available to the user 100 with respect to the return of an item or refund request for purchased item or service.

At block 521, the return management service 103 can generate a user interface 109 comprising the one or more recommendations associated with the output of the LLM 112. For example, FIG. 1 illustrates a user interface 109b that includes two recommendations for the return of Item B. One recommendation provides details if the user 100 were to exchange the item for another item. The other recommendation provides details for if the user 100 were to receive a refund for the return of the item. In various examples, the user 100 can use the recommendations included on the user interface 109 to better understand how the policy may apply to his or her specific purchase and/or whether there are other benefits for the user with regard to a return and/or a refund for the item.

At block 524, the return management service 103 can send the user interface 109 or corresponding user interface code to the client application 273 for rendering on the client device 106. For example, the return management service 103 may transmit user interface code that can be executed by the client application 273 to generate and render the user interface 109 on the client device 106. In other examples, the return management service 103 can transmit the generated user interface 109 to the client device 106 for rendering. For example, the return management service 103 can send data associated with the generated user interface 109 in response to an application programming interface (API) call from the client application 273.

At block 527, the client application 273 can transmit a selected return recommendation to the return management service 103. For example, the user interface 109 can include one or more selectable components 115 that upon selection by the user 100 can notify the return management service 103 the path the user 100 wishes to take with respect to the return of the item.

At block 530, the return management service 103 can initiate the return of the item on behalf of the user 100 based at least in part on the selected return recommendation. For example, the return management service 103 can communicate with the merchant and/or issuer associated with the transaction to indicate the return/refund request. In various examples, the communications can be in the form of a message (e.g., email, SMS, etc.), a voice call, and/or other sort of communications. In some examples, the return management service 103 can initiate conversations with the merchant and/or issuer via the communication engine 215. In some examples, the communication engine 215 can comprise a message generation service, a chatbot service, a phonebot service, and/or other type of communication service that can be automated. For example, the communication engine 215 can generate a draft communication (e.g., email, SMS, etc.) based at least in part on the user's purchase of Item B, and between a return workflow conversation with the merchant via the appropriate communication channel. In another example, the communication engine 215 can initiate an outbound call to the merchant and/or issuer via a voice bot if voice functionality is required. Thereafter, this portion of the process proceed to completion.

A number of software components previously discussed are stored in the memory of the respective computing devices and are executable by the processor of the respective computing devices. In this respect, the term “executable” means a program file that is in a form that can ultimately be run by the processor. Examples of executable programs can be a compiled program that can be translated into machine code in a format that can be loaded into a random-access portion of the memory and run by the processor, source code that can be expressed in proper format such as object code that is capable of being loaded into a random-access portion of the memory and executed by the processor, or source code that can be interpreted by another executable program to generate instructions in a random-access portion of the memory to be executed by the processor. An executable program can be stored in any portion or component of the memory, including random-access memory (RAM), read-only memory (ROM), hard drive, solid-state drive, Universal Serial Bus (USB) flash drive, memory card, optical disc such as compact disc (CD) or digital versatile disc (DVD), floppy disk, magnetic tape, or other memory components.

The memory includes both volatile and nonvolatile memory and data storage components. Volatile components are those that do not retain data values upon loss of power. Nonvolatile components are those that retain data upon a loss of power. Thus, the memory can include random-access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, or other memory components, or a combination of any two or more of these memory components. In addition, the RAM can include static random-access memory (SRAM), dynamic random-access memory (DRAM), or magnetic random-access memory (MRAM) and other such devices. The ROM can include a programmable read-only memory (PROM), an erasable programmable read-only memory (EPROM), an electrically erasable programmable read-only memory (EEPROM), or other like memory device.

Although the applications and systems described herein can be embodied in software or code executed by general purpose hardware as discussed above, as an alternative the same can also be embodied in dedicated hardware or a combination of software/general purpose hardware and dedicated hardware. If embodied in dedicated hardware, each can be implemented as a circuit or state machine that employs any one of or a combination of a number of technologies. These technologies can include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The sequence diagrams show the functionality and operation of an implementation of portions of the various embodiments of the present disclosure. If embodied in software, each block can represent a module, segment, or portion of code that includes program instructions to implement the specified logical function(s). The program instructions can be embodied in the form of source code that includes human-readable statements written in a programming language or machine code that includes numerical instructions recognizable by a suitable execution system such as a processor in a computer system. The machine code can be converted from the source code through various processes. For example, the machine code can be generated from the source code with a compiler prior to execution of the corresponding application. As another example, the machine code can be generated from the source code concurrently with execution with an interpreter. Other approaches can also be used. If embodied in hardware, each block can represent a circuit or a number of interconnected circuits to implement the specified logical function or functions.

Although the sequence diagrams show a specific order of execution, it is understood that the order of execution can differ from that which is depicted. For example, the order of execution of two or more blocks can be scrambled relative to the order shown. Also, two or more blocks shown in succession can be executed concurrently or with partial concurrence. Further, in some embodiments, one or more of the blocks shown in the sequence diagrams can be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein that includes software or code can be embodied in any non-transitory computer-readable medium for use by or in connection with an instruction execution system such as a processor in a computer system or other system. In this sense, the logic can include statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. Moreover, a collection of distributed computer-readable media located across a plurality of computing devices (e.g., storage area networks or distributed or clustered filesystems or databases) may also be collectively considered as a single non-transitory computer-readable medium.

The computer-readable medium can include any one of many physical media such as magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium can be a random-access memory (RAM) including static random-access memory (SRAM) and dynamic random-access memory (DRAM), or magnetic random-access memory (MRAM). In addition, the computer-readable medium can be a read-only memory (ROM), a programmable read-only memory (PROM), an erasable programmable read-only memory (EPROM), an electrically erasable programmable read-only memory (EEPROM), or other type of memory device.

Further, any logic or application described herein can be implemented and structured in a variety of ways. For example, one or more applications described can be implemented as modules or components of a single application. Further, one or more applications described herein can be executed in shared or separate computing devices or a combination thereof. For example, a plurality of the applications described herein can execute in the same computing device, or in multiple computing devices in the same computing environment.

Disjunctive language such as the phrase “at least one of X, Y, or Z,” unless specifically stated otherwise, is otherwise understood with the context as used in general to present that an item, term, etc., can be either X, Y, or Z, or any combination thereof (e.g., X; Y; Z; X or Y; X or Z; Y or Z; X, Y, or Z; etc.). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications can be made to the above-described embodiments without departing substantially from the spirit and principles of the disclosure. All such modifications and variations are intended to be included herein within the scope of this disclosure and protected by the following claims.

Therefore, the following is claimed:

1. A system, comprising:
a computing device comprising a processor and a memory; and
machine-readable instructions stored in the memory that, when executed by the processor, cause the computing device to at least:
receive a return request from a client device associated with a user, the return request corresponding to a return of an item associated with a transaction;
identify stored data associated with the transaction, the stored data comprising user data, merchant data, and issuer data;
generate a plurality of prompts associated with the stored data;
apply the plurality of prompts to a large language model (LLM);
determine a return recommendation based at least in part on an output of the LLM;
generate a user interface comprising the return recommendation; and
transmit the user interface to the client device.

2. The system of claim 1, wherein the user data comprises at least one of user communication data, user transaction data, or a user persona profile associated with return behavior of the user.

3. The system of claim 1, wherein the merchant data corresponds to a merchant associated with the transaction and comprises at least one of merchant policy data, merchant communication data, or a merchant persona profile associated with return behavior of the merchant.

4. The system of claim 1, wherein the issuer data is associated with an issuer of a payment account of the user associated with the transaction, the issuer data comprising transaction data and benefit data associated with the issuer.

5. The system of claim 1, wherein the machine-readable instructions further cause the computing device to at least:
receive a user selection of the return recommendation from the user interface; and
initiate the return of the item between the user and a merchant associated with the transaction based at least in part on the return recommendation.

6. The system of claim 5, wherein, for initiating the return of the item, the machine-readable instructions further cause the computing device to at least:
generate a communication on behalf of the user indicating the return of the item; and
send the communication to a merchant computing device associated with the merchant.

7. The system of claim 1, wherein the LLM is trained on historical data associated with a plurality of transactions and a plurality of returns obtained from a plurality of users, a plurality of merchants, and a plurality of issuers.

8. A method, comprising:
registering a user with a return management service in response to receiving a registration request from a client device associated with the user, the return management service functioning as an intermediary between the user and a merchant with respect to one or more item returns;
obtaining user data associated with the user based at least in part on permissions granted during registration of the user with the return management service;
obtaining merchant data associated with at least one or more merchants;
obtaining issuer data associated with one or more issuers of payment instruments of the user;
generate training inputs based at least in part on the user data, the merchant data, and the issuer data; and
training a large language model (LLM) based at least in part on the training inputs, the LLM being trained to make one or more recommendations associated with the one or more item returns.

9. The method of claim 8, further comprising storing the user data, the merchant data, and the issuer data in at least one database.

10. The method of claim 8, wherein the user data is associated with a plurality of transactions between the user and at least one of the one or more merchants.

11. The method of claim 8, wherein the user data comprises communication data that is obtained from a communication server associated with a communication account of the user.

12. The method of claim 8, further comprising:
receiving a return request, from the client device associated with the user, for a return of an item associated with a transaction; and
determining at least one return recommendation with respect to the return of the item based at least in part on the LLM.

13. The method of claim 8, further comprising:
identifying a transaction in response to an analysis of at least one of the user data, merchant data, or issuer data; and
identifying a portion of the user data, a portion of the merchant data, and a portion of the issuer data associated with the transaction based at least in part on a time window associated with a date of the transaction, the training inputs being generated based at least in part on the portion of the user data, the portion of the merchant data, and the portion of the issuer data.

14. The method of claim 8, wherein the merchant data comprises merchant policy data and merchant communication data.

15. A non-transitory, computer-readable medium, comprising machine-readable instructions that, when executed by a processor of a computing device, cause the computing device to at least:
detect a transaction between a user and a merchant;
obtain user data associated with the user during a time window associated with a date of the transaction;
poll a merchant computing environment for merchant data associated with the merchant during the time window;
obtain issuer data associated with an issuer of a payment instrument used during the transaction; and
store the user data, the merchant data, and the issuer data in association with the transaction.

16. The non-transitory, computer-readable medium of claim 15, wherein the machine-readable instructions, when executed by the processor, further cause the computing device to at least:
receive a registration request from a client device associated with the user; and
register the user with a return management that acts as an intermediary between the user and a merchant with respect to one or more item returns.

17. The non-transitory, computer-readable medium of claim 15, wherein the machine-readable instructions, when executed by the processor, further cause the computing device to at least:
receive a return request for a return of an item associated with the transaction from a client device associated with the user; and
determine at least one return recommendation with respect to the return of the item.

18. The non-transitory, computer-readable medium of claim 17, wherein the machine-readable instructions, when executed by the processor, further cause the computing device to at least:
obtain the user data, the merchant data, and the issuer data stored in association with the transaction;
generate a plurality of prompts based at least in part on the user data, the merchant data, and the issuer data; and
apply the plurality of prompts to a trained large language model (LLM), the at least one return recommendation being based at least in part on an output of the LLM.

19. The non-transitory, computer-readable medium of claim 17, wherein the machine-readable instructions, when executed by the processor, further cause the computing device to at least:
generate a user interface including the at least one return recommendation;
transmit the user interface to the client device;
receive a selection of a selected return recommendation of the at least one return recommendation; and
initiate the return of the item based at least in part on the selected return recommendation.

20. The non-transitory, computer-readable medium of claim 17, wherein the merchant data comprises merchant policy data and merchant communication data, the user data comprises user communication data and user interaction history, and the issuer data comprises benefit data associated with the payment instrument.
